(19) United States
(12) Patent Application Publication
(10) Pub. No.: US 2010/0261509 A1
(43) Pub. Date: Oct. 14, 2010

(54) Vibration Modulation Applications and Techniques in Mobile devices

(75) Inventors: Surya Kumar Kovvali, Westborough, MA (US); Ramji Raghavan, Winchester, MA (US); Krishnan Ramakrishnan, Hopkinton, MA (US); Pramod Kalyanasundaram, Acton, MA (US)

Correspondence Address: Nields, Lemack & Frame, LLC, 176 E. Main Street, Suite #5, Westborough, MA, 01581, US

(73) Assignee: MOVIK NETWORKS, Littleton, MA (US)

(21) Appl. No.: 12/757,663

(22) Filed: Apr. 9, 2010

Related U.S. Application Data
(60) Provisional application No. 61/168,482, filed on Apr. 10, 2009.

(51) Int. Cl. H04B 1/38

(52) U.S. Cl. 455/567

(57) ABSTRACT

Methods and applications for modulating the vibration mode of cellular handsets using patterned sequences are disclosed. This modulation allows additional information to be conveyed, thereby communicating messages in a variety of domains before the user responds to the vibration alert. This modulation may cause different patterns of vibration to convey additional information such as the importance of the call, identity of the caller, and other such information. The invention further extends vibration modulation to additional gaming and music & entertainment applications, such as rhythm synchronization, dance/step synchronization in a group, aerobic and other physical exercise related applications.

This application claims priority of U.S. Provisional Patent Application Ser. No. 61/168,482, filed Apr. 10, 2009, the disclosure of which is incorporated herein by reference in its entirety.

### BACKGROUND OF THE INVENTION

Ring tones and caller tones, in which alternative types of rings are initiated in the mobile handset, are very common. These different ring tones allow users to select alternative types of ring tones based on local settings in the handset. Ring tones currently may be preloaded tones, available with the handset. Alternatively, there are multiple mechanisms available that allow a user to download additional ring tones, which may be excerpts of songs, theme songs from movies or TV shows, or dialogue.

Various handsets also allow the user to configure multiple ring tone settings, based on attributes, such as caller ID. These specialized ring tones, also known as caller tones, allow the caller to send his/her personalized tone, thereby identifying the caller to the receiver before the called party answers the call.

Handsets typically support silent or vibrate mode in which the handset suppresses the audio tone when a call is received, but may alert the user by vibration. The vibration mode silently alerts the receiver without causing disruption in the environment in which the user is situated. This is especially useful, for example, in a meeting, movie, hospital and other public environments. However, when the user configures the handset in the vibration mode, the caller type, call-importance and other attributes that are conveyed through selective ring tones or caller tones are lost, since the audio rings are suppressed.

Thus, there exists a need for a system and method by which a user can silently be alerted of incoming calls and messages, while maintaining the additional attributes that selective ring tones provide.

### SUMMARY OF THE INVENTION

The current invention proposes modulating the vibration of a portable device such as a mobile handset, so that vibration patterns are different. The actual number of differing vibration patterns and types of difference in the vibration pattern will be different for different handsets. The selection of vibration pattern, from the available set could be a local configuration, similar to ring tones, or sent by the caller, for example. In another embodiment, the emergency call could be a rapid vibration with short pauses. The invention further extends the use of vibration patterns, and modulation of vibration to potential applications such as mobile handset based games, synchronization steps in music (Metronome), dance, and exercise for achieving rhythm and pacing. In music learning and teaching applications, Metronome devices currently use audio, or visual methods for generating periodic indications to maintain beat or tempo. Such methods are intrusive or not suitable for certain environments, for example, in some scenarios, the learner needs to watch the corresponding displays or mechanical device. The current invention uses vibration mechanism in mobile handsets for such applications

### BRIEF DESCRIPTION OF THE FIGURES

FIG. 1 represents various vibration control parameters;

FIG. 2 represents the format of a MPEG frame; and

FIG. 3 represents a schematic diagram of a mobile handset.

### DETAILED DESCRIPTION OF THE INVENTION

The present invention describes the use of vibration control in mobile handsets and other mobile devices to create distinguishable patterns of vibration. Most handsets allow the possibility of vibration, typically through the use of piezo-electric devices. These distinguishable patterns of vibration can then be used in a variety of ways. In one embodiment, the patterns of vibration are used to convey the attributes and information that is currently conveyed through the use of multiple or selective ring tones.

The patterns of vibration are mapped in an application dependent way to convey different indications to the user. Various parameters can be used to control the vibration of the device, including, but not limited to:

(1) Amplitude of vibration,

(2) Frequency,

(3) Vibration-ON time (Tₒₙ),

(4) Vibration-Pause time (Tₚₐᵤₛₑ), and

(5) Total duration of Vibration (Tₜₒₜₐₗ).

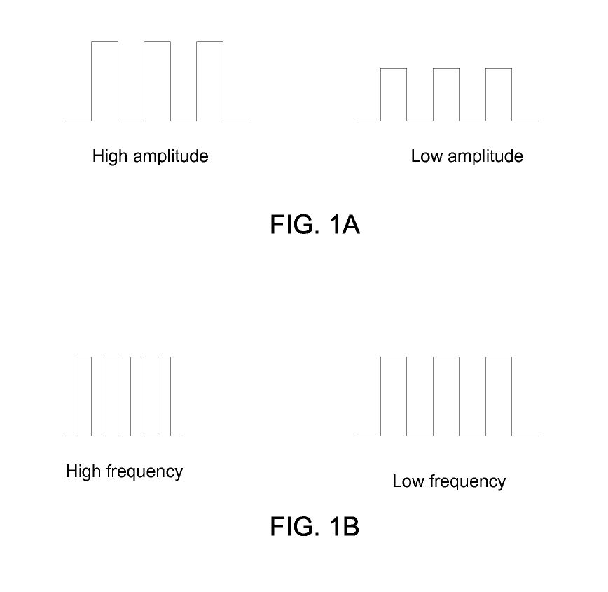

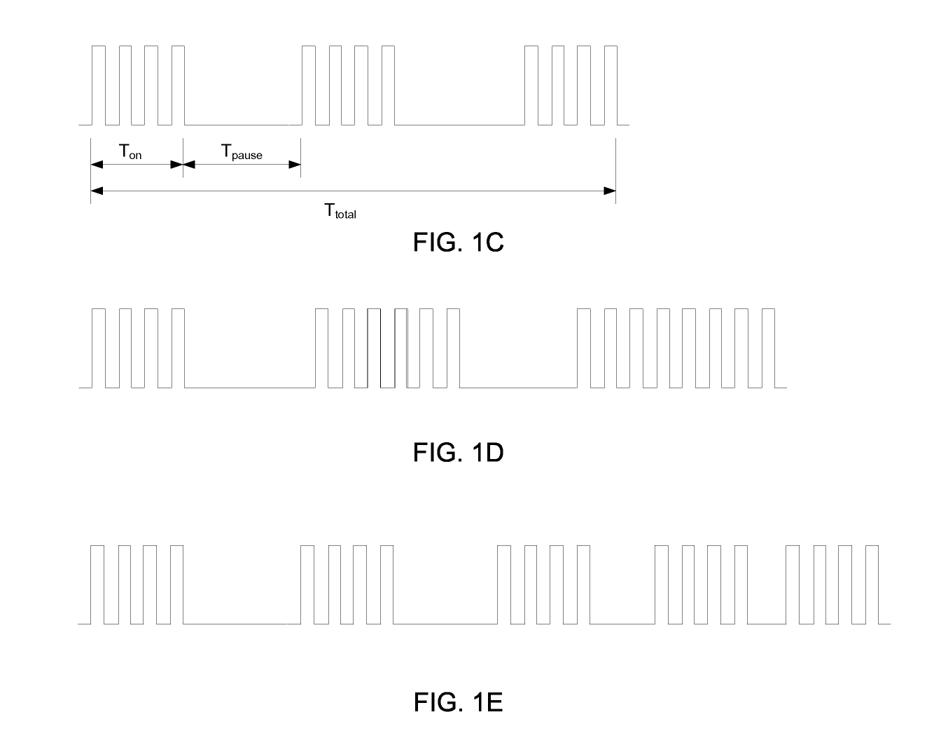

FIG. 1 shows these various parameters. FIG. 1A shows that the handset can be programmed to output square waves of varying amplitudes. These changes in amplitude produce tactile differences for the user. FIG. 1B shows that the handset can be programmed to utilize square waves of varying frequency. FIG. 1C shows a sequence of square wave pulses. In this embodiment, the duration of the square wave, or vibration on time (Tₒₙ), may be varied. Alternatively or additionally, the time between square waves, of the vibration pause time (Tₚₐᵤₛₑ), may also be varied. In addition, the total length of the sequence (Tₜₒₜₐₗ) may also be varied. For example, in some embodiments, a set of three vibrations may constitute a sequence, while in other embodiments, a different number of vibrations may constitute a sequence. Addition patterns may be created by using non-uniform vibration on times and/or vibration pause times.

For example, in the embodiment shown in FIG. 1C, the vibration on time (Tₒₙ) remains constant throughout the sequence. Similarly, the vibration pause time (Tₚₐᵤₛₑ)) remains constant. FIG. 1D shows a sequence of pulses where the vibration on time (Tₒₙ) gets progressively longer during the sequence, while the vibration pause time (Tₚₐᵤₛₑ) remains constant. FIG. 1E shows a sequence of pulses where the vibration pause time (Tₚₐᵤₛₑ) gets progressively shorter during the sequence, while the vibration on time (Tₒₙ) remains constant. In addition, both the vibration on time (Tₒₙ) and the vibration pause time (Tₚₐᵤₛₑ) can both vary during the sequence.

The number of easily identifiable vibration patterns may be dependent on the user, the type of device, and the application that uses the patterns. For example, for existing handsets without additional hardware mechanisms, a small number of vibration patterns are sufficient to identify attributes, such as the priority of the call, or the group of caller (family, work, friends etc.)

For example, suppose two patterns are desired by an application. Those patterns may be (1) short vibration on time (Tₒₙ) and (2) long vibration on time (Tₒₙ) or (1) short vibration pause time (Tₚₐᵤₛₑ) and (2) long vibration pause time (Tₚₐᵤₛₑ) . When more than 2 unique patterns are desired, the above methods could be combined to create additional patterns. In the same manner in which a user selects different ring tones for different caller IDs, the user may map different vibration patterns to different caller IDs. For example all calls from home numbers could be mapped to a first pattern, known as Vibration-Pattern 1. Calls from the user's spouse may be mapped to a second pattern, known as Vibration-Pattern 2.

In additional, hardware modifications can be made to new mobile handsets to allow for more vibration patterns. For example, new handsets may include the hardware required to modify the amplitude and/or the frequency of the vibration, as shown in FIGS. 1A-B. These changes allow the creation of more distinct vibration patterns.

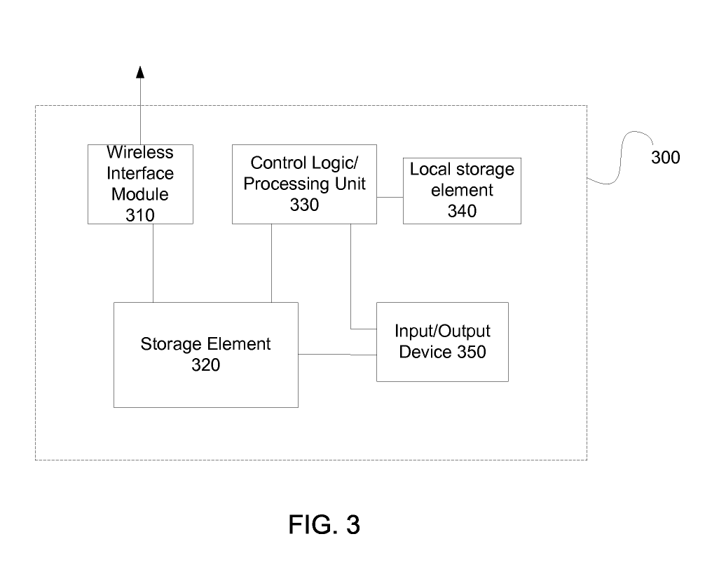

FIG. 3 shows a schematic drawing of a handset 300. A mobile handset or device is adapted to receive and transmit data, such as voice and data, on a wireless interface 310. The received data may be placed into a storage element 320, typically a semiconductor storage element such as a RAM, DRAM or an equivalent technology. The movement of data from the interface module 310 to the memory 320 and vice versa may be accomplished using dedicated hardware, such as a DMA controller (not shown). Alternatively, a dedicated data movement processor may be used to handle the actual movement of data through the mobile device. Once stored within the device, the information is processed in accordance with the present invention. This may be done using dedicated control logic or a processing unit 330. The control logic/processing unit 330 may have its own local storage element 340, which contains instructions to execute and local status. This storage element 340 may be RAM or DRAM. In addition, at least a portion of this storage element 340 may be non-volatile, such as ROM, FLASH ROM, Solid State Disk, or the like. Using known specifications and protocols, the control logic/processing unit 330 parses the received information to understand the packet at each protocol layer. The control logic/processing unit 330 may be physically implemented in a variety of technologies. For example, it may be a general-purpose processor, executing a set of instructions from an internal or external storage device.

In another embodiment, a dedicated hardware device having embedded instructions or state machines may be used to perform the functions described. Throughout this disclosure, the terms “control logic” and “processing unit” are used interchangeably to designate an entity adapted to perform the set of functions described.

The mobile device 300 also contains software capable of performing the functions described herein. The software may be written in any suitable programming language and the choice is not limited by this disclosure. Additionally, all applications and software described herein are computer executable instructions that are contained on a computer-readable media. For example, the software and applications may be stored in a read only memory, a rewritable memory, or within an embedded processing unit. The particular computer on which this software executes is application dependent and not limited by the present invention.

The handset 300 also includes input/output device 350, which may include a keypad, a touch screen, a video display, an LCD screen or other suitable means. The control logic 330 may communicate with the input/output device 350 directly. In other embodiments, data from the storage element 320 is delivered to the output device directly. Another type of input/output device 350 is a piezo-electric device, which is adapted to vibrate when energized.

The use of various vibration patterns and the ability to create these patterns allow for many new applications and uses.

For example, in one embodiment, a downloadable application or an application stored in the mobile device determines the time sequencing or activation of specific vibration patterns relative to the start of the application activation. In another embodiment, in a network based client-server application, the server application sends messages to the client, indicating type of vibration pattern, and presentation time stamp relative to the launching of the application, or relative to the previous presentation timestamp.

In either embodiment, the application resident of the device activates the specific vibration pattern as the application run-time reaches the specified presentation time for the pattern. In one embodiment, the synchronization mechanism is similar to that used for the Audio/Video synchronization in multi-media streams. The difference is that the type of content (vibration) specified in the present invention is not currently defined as a component of multi-media content. A detailed description of one embodiment of this usage is described below.

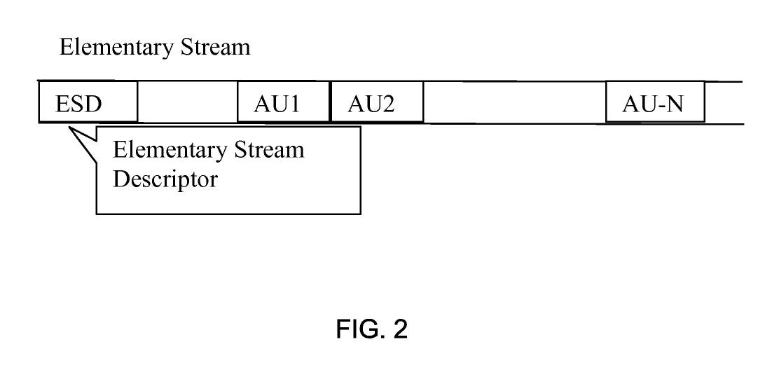

A multimedia server uses MPEG-2/4 to transport multimedia content (either live multimedia content, or stored multimedia files). MPEG4 uses one or more elementary streams (ES) where each ES is a flow of multimedia data from a single source to a destination. Each Elementary Stream contains one or more Access Units (AU) as shown in FIG. 2. The Access Unit is the smallest data unit to which timing information is associated. The multimedia types, such as audio, video, and sub-types (within the audio, video types) are specified using MIME types. For example, the Internet Assigned Numbers Authority (IRNA) specified media types include (1)application, (2)audio, (3)image,(4)message, (5)model, (6)multipart, (7)text, and (8)video.

Within some of these media type, a number of subtypes are defined. For example, within the audio media type, various sub types exist, including 3GPP, ac3, AMR, MPEG4 and others.

The present invention extends the above IRNA media types to include “Vibration”. Within the media type, an application usage could define additional subtypes, which include the various vibration patterns. By supplying an Elementary Stream having a plurality of AU's allows the creation of complex sequences of synchronized vibration patterns.

One example application is to convey dance steps for a Music Video using vibration patterns. Assume that there are 4 dance steps, (S1) left foot forward, (S2) left foot backward, (S3)right foot forward, and (S4) right foot backward. These four steps could be mapped to 4 vibration patterns using any or all of the parameters shown in FIG. 1. A distinct vibration pattern code may be assigned for each of the 4 steps.

After these new media types and subtypes are defined, a new access unit (AU) may be constructed for the vibration pattern, whereby the particular code and timing is specified in a manner similar to other AU streams. A portable device, such a mobile handset, receives this new multi-media stream, decodes the vibration pattern codes and causes the vibration patterns to be created in the portable device at the times specified by the access unit. Thus, a user carrying the device receives a non-intrusive indication of dance step, independent of the corresponding audio or video or both. In other words, if the user has impaired hearing or is in a noisy environment, the user could still execute the dance steps correctly.

Additionally, the present invention further extends the use of uniquely identifiable vibration patterns in a mobile handset for many other applications.

A first application may be the use of vibration as an aid in learning music. For example, while learning a piece of music (vocal or instrumental), the learner may benefit from silent indications for maintaining pace, or silent indications of musical transitions. Thus, a music teaching application could map transition points in music as vibration triggers. Such a trigger could be simple trigger, such as a brief vibration on (Tₒₙ), such a fraction of a second,) that merely indicates change. In other embodiments, more complex mappings, such as a plurality of notes mapped to a corresponding number of unique vibration patterns. Thus, when a vibration trigger is presented, it identifies the associated transition in the music application. Such a mechanism may also be applicable in a group learning environment, where the teacher/conductor controls the music application to one or more students, where all the students/members have a mobile handset device. In this way, all members simultaneously receive vibration triggers, which facilitate rhythm synchronization within the group.

In some embodiments, a network application, transmits an Elementary Stream, which consists of a sequence of AU's where each represents the vibration pattern and presentation time. This ES can be used to create the required sequence of vibration patterns. In another embodiment, a different protocol can be used, which defines the vibration pattern and includes an indication of presentation time, where the indication may be an absolute time, a relative time since the last presentation time, or a relative time since the launch of the application, or another indicator. This protocol can be applied to both network based applications, or standalone applications which are resident on the mobile device.

Another application is the use of vibration triggers in a dance teaching and learning applications For example, a simple dance uses small number of steps, and the steps would have to be performed in a rhythmic way, and a number of participants perform the steps close to each other. Consider a dance type with 4 types of movements, (1) left step, (2) right step, (3) forward step, and (4) backward step. These four steps could be mapped to a corresponding number of vibration patterns. The teacher/leader runs the Server application that converts dance-steps, to vibration patterns. The application in the Mobile handsets receives the triggers from the server and causes the vibration patterns, thus alerting the user of the corresponding rhythmic step. As outlined in the previous section, in a network based application, the server maintains the application time stamp, and sends message in advance of a vibration mode trigger, indicating the vibration type, and presentation time stamp for the current vibration type. The client program maintains program run time, and triggers the pattern when the application run time reaches the vibration pattern presentation time. In other embodiments, a different number of steps, or a different sequence of steps may be used. In another embodiment, a different protocol can be used, which defines the vibration pattern and includes an indication of presentation time, where the first indication may be absolute, but subsequent indications may be either an absolute time, or a relative time since the last presentation time, or another indicator.

Another example is the use of vibration patterns to maintain pacing or timing in physical activities, such as aerobic, yoga and other exercises. These activities often require performing a series of steps, and maintaining a certain pace between the steps, and holding a certain amount of time at each step. For example, Sun-Salutation yoga practice requires a sequence that includes a starting position, followed by lifting both arms from the starting position, holding that position for a few seconds, bringing both arms forward to touch both feet, holding that position for a defined number of seconds, and then returning to the starting position. Since the sequence is followed in same order, these 3 basic steps could be mapped to a single trigger that indicates transition to the next step, or to three vibration patterns, each uniquely identifying the subsequent yoga step. A similar approach can be applied to step aerobics, or other physical activities.

Another possible application of the present invention is its use to provide a vibration indication to control pacing in outdoor exercises, such as running or walking. In these types of activities, maintaining pace is important. Existing exercise/gaming devices, such as Wii, provide feedback for pace by requiring user to watch the program display and follow the leader. In other words, the leader runs at a predefined pace, and the user maintains the same pace through visual indication. Unlike the visual feedback in the Wii type of device, the vibration modulation method of the present invention provides pacing feedback by vibration patterns generated in a mobile handset device, and thus provides pacing assistance for outdoor running or walking. Also the vibration pattern could be used for the pacing steps while audio/visual indications could be used for other applications. For example, in outdoor walking, vibration pattern could be used for pacing while audio used for listening music. In one embodiment, a mobile software application accepts user entered configuration data for pacing control (for example, user's desired running or walking rate in MPH) and generates periodic vibration patterns to match the desired pace. These patterns may occur at regular intervals such as every other step, every tenth step, or at fixed distances.

In other embodiments, the vibration can be used to enhance the experience for mobile handset based game applications. For example, while playing a game on a mobile handset, the game application typically presents the audio and visual attributes of the game, and the user interacts with specific key activations depending on the present situation in the game. Vibration patterns can be used to facilitate additional effects for a richer experience, or as indications for specific user actions.

Another application of the present invention is using vibration patterns to non-intrusively alert users. As previously mentioned, vibration mode can be manually set by a user to minimize the interruption caused by an incoming phone call, email or text message. However, in current handsets, this features needs to be manually enabled. Typically, the mobile handset and/or the network are aware of the geographical location of the handset (either through GPS in GPS capable devices, or from the network through the mobile network). Therefore, based on this information, an application in the device or a network-based application can determine the current location of the device. Using the location information, an application can determine the physical location of the device, such as in a hotel, sports stadium, place of worship, or other structure. The application can then automatically adjust the type of alert notification (i.e. ring tone vs. vibration pattern) based on the environment. High noise locations may be best served through the use of vibration, since an audio alert may not be heard. Similarly, a vibration alert may be best in locations where interruptions are unwelcome, such as a movie theater or place of worship.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A mobile device comprising control logic adapted to generate a plurality of distinct vibration patterns, wherein said patterns are made by varying a vibration characteristic.

2. The mobile device of claim 1, wherein said vibration characteristics are selected from the group consisting of amplitude, frequency, vibration on time, vibration pause time and total time.

3. The mobile device of claim 1, wherein one of said plurality of distinct vibration patterns is used to identify a particular caller.

4. The mobile device of claim 1, wherein one of said plurality of distinct vibration patterns is used to identify a particular group of callers.

5. The mobile device of claim 1, wherein said mobile device transmits an alert, wherein said alert may be audio or a vibration, and the type of alert is determined based on the location of said mobile device.

6. The mobile device of claim 1, further comprising a storage element adapted to store an application, whereby said application emits one of said vibration patterns.

7. The mobile device of claim 6, wherein said application emits a plurality of vibration patterns at specific times.

8. The mobile device of claim 7, wherein said specific time is relative to the launch of said application.

9. The mobile device of claim 7, wherein said specific time is relative to the emission of a previous vibration pattern.

10. The mobile device of claim 7, wherein said specific time is based on the time of day.

11. The mobile device of claim 1, wherein said mobile device is in communication with a network and said network directs said mobile device to emit one of said vibration patterns using a network-based application.

12. The mobile device of claim 11, wherein said network-based application transmits elementary streams to said device, whereby said elementary stream comprises a plurality of vibration patterns and indications of time associated with each said pattern.

13. The mobile device of claim 12, wherein said network-based application utilizes MPEG2/4 multimedia format.

14. A network-based application for execution on a mobile device, comprising:
computer readable media, comprising instructions adapted to be executed on a processing unit on said mobile device, said instructions comprising means to indicate a vibration pattern from a plurality of vibration patterns to be emitted by said mobile device, and an indication of the time to emit said pattern.

15. The network based application of claim 14, wherein said indication of time is relative to the launch of said application.

16. The network based application of claim 14, wherein said indication of time is relative to a previous emitted vibration pattern.

17. The network based application of claim 14, wherein said indication of time is based on the time of day.

18. The network based application of claim 14, further providing instructions to transmit video and audio data to said mobile device, wherein said video and audio data is synchronized with said vibration patterns.
